(19) United States
(12) Patent Application Publication
(10) Pub. No.: US 2017/0090716 A1
(43) Pub. Date: Mar. 30, 2017

(54) COMPUTER PROGRAM FOR OPERATING OBJECT WITHIN VIRTUAL SPACE ABOUT THREE AXES

(71) Applicant: COLOPL, INC., Tokyo (JP)

(72) Inventors: Atsushi INOMATA, Kanagawa (JP); Hideyuki KURIBARA, Tokyo (JP)

(21) Appl. No.: 15/275,182

(22) Filed: Sep. 23, 2016

(30) Foreign Application Priority Data
Sep. 24, 2015 (JP) 2015-186628

(51) Int. Cl. G06F 3/0481; G06F 3/0488; G06F 3/0484; G06F 3/041

(52) U.S. Cl. CPC G06F 3/04815; G06F 3/0416; G06F 3/04886; G06F 3/04883; G06F 3/04845

(57) ABSTRACT

A system includes a non-transitory computer readable medium for storing instructions for operating an object within a virtual space about three axes. The system further includes a computer for executing the instructions for causing the computer to function as a region allocation unit configured to allocate a first region and a second region to an inside of an operation region. The computer is further configured to function as a command generation unit configured to generate, in response to a first input operation within the first region, a first operation command to operate the object relating to a first axis and a second axis within the virtual space. The command generation unit is further configured to generate, in response to a second input operation within the second region, a second operation command to operate the object relating to a third axis within the virtual space.

### RELATED APPLICATIONS

The present application claims priority to Japanese Patent Application Number 2015-186628, filed Sep. 24, 2015, the disclosure of which is hereby incorporated by reference herein in its entirety.

### BACKGROUND

1. Field

The present description relates to a computer-implemented method. More specifically, the present description relates to a computer-implemented method of operating an object arranged within a virtual space about three axes through a user's intuitive input operation.

2. Description of the Related Art

In recent years, as a game using a smartphone (hereinafter referred to as “smartphone game”) and a game using a head-mounted display (hereinafter referred to as “HMD”), 3D games using three-dimensional graphics have become widespread. In some of those 3D games, an object is arranged within a three-dimensional virtual space (game space), and a user can operate the object three-dimensionally. An example of such a 3D game, is a 3D game involving a three-dimensional rotation operation on an object.

In general, a user operates a controller to issue an operation command to an object within a three-dimensional space. Examples of the controller include a dedicated game console and a smartphone. A controller operation in a 3D game is generally limited to a planar two-dimensional operation. Examples of the planar two-dimensional operation include an operation of a directional pad or a joystick, in the case of a game console, and a touch operation on a touch panel, in the case of a smartphone.

In the related art disclosed in Japanese Patent Application Laid-open No. 2013-171544 (in particular, paragraphs [0093] to [0095] and FIG. 8(B)), a virtual push switch assigned with a function “Rotation” is arranged on a screen to allow a user to operate the virtual push switch. Specifically, triangle marks are displayed in upper, lower, left, and right portions of the virtual push switch, respectively. When the user presses a position in which the upward or downward triangle mark is located, an object is rotated about a horizontal axis. When the user presses a position in which the leftward or rightward triangle mark is located, the object is rotated about a vertical axis. In other words, in the related art disclosed in Japanese Patent Application Laid-open No. 2013-171544, a two-dimensional user operation is associated with an operation about two axes within a three-dimensional space.

With the related-art object rotation operation within the three-dimensional virtual space disclosed in Japanese Patent Application Laid-open No. 2013-171544, the object can be operated only about two axes, and the user has difficulty in smoothly adjusting angles as intended by himself or herself. In order to enable smooth angle adjustment, an operation about three axes needs to be enabled instead of the operation about two axes. Meanwhile, for example, when a 3D object is drawn with related-art drawing software, at the time of rotation about three axes, a user is generally prompted to specify rotation angles corresponding to respective axes of the rotation (the user is prompted to specify numerical values, e.g., “30 degrees”).

### SUMMARY

In view of the above, an object of at least one embodiment of the present description is to provide an interface for a user's intuitive input operation, which is used when an object within a three-dimensional virtual space is operated about three axes. In at least one embodiment, an object of the present description is to provide a computer-implemented method enabling efficient generation of a command to operate an object about three axes through the interface. The computer-implemented method is executed by at least one processor executing instructions of a computer program.

In order to help solve the above-mentioned problems, according to at least one embodiment, there is provided a computer program for operating an object within a virtual space about three axes and for causing a computer to function as a region allocation unit configured to allocate a first region and a second region to an inside of an operation region. The computer is further caused to function as a command generation unit configured to generate, in response to a first input operation within the first region, a first operation command to operate the object relating to a first axis and a second axis within the virtual space; and generate, in response to a second input operation within the second region, a second operation command to operate the object relating to a third axis within the virtual space.

Features and advantages of the present description become apparent from the descriptions and illustrations of the detailed description given below, the accompanying drawings, and the appended claims.

### BRIEF DESCRIPTION OF THE DRAWINGS

FIG. 1 is a schematic diagram for illustrating a mobile terminal as an example of a user terminal for executing a computer program according to at least one embodiment.

FIG. 2 is a block diagram for schematically illustrating a configuration of the mobile terminal of FIG. 1.

FIG. 3 is a block diagram for illustrating an outline of input and output in the mobile terminal of FIG. 2.

FIG. 4 is a schematic diagram for illustrating an example of arrangement of an object within a three-dimensional virtual space.

FIG. 5 is a schematic diagram for illustrating the object arranged within the three-dimensional virtual space and contained in a field of view from a virtual camera.

FIG. 6 is a schematic diagram for illustrating an outline of a user operation for operating the object about three axes according to at least one embodiment.

FIG. 7 is a schematic diagram for illustrating how an example of an operation is performed in which the object arranged within the three-dimensional virtual space is operated in response to a user operation using the user terminal according to at least one embodiment.

FIG. 8 is a table for showing the association between a touch operation and an object operation command.

FIG. 9 is a diagram for illustrating main functional blocks for generating a user operation command implemented through use of the computer program according to at least one embodiment.

FIG. 10 is a flowchart for illustrating processing for generating the user operation command implemented through use of the computer program according to at least one embodiment.

FIG. 11 is a flowchart for illustrating detailed information processing relating to Step S105 of FIG. 10.

FIG. 12 is a schematic conceptual diagram for illustrating at least one example, in which an object operation is displayed on the user terminal through execution of the computer program according to at least one embodiment.

FIG. 13 is a functional block diagram according to at least one example of at least one embodiment.

FIG. 14 is a processing flowchart according to at least one example of at least one embodiment.

FIG. 15 is a schematic diagram for illustrating a system configuration according to at least one example, in which the object operation is displayed on an HMD through execution of the computer program according to at least one embodiment.

FIG. 16 is a schematic conceptual diagram according to at least one example of at least one embodiment.

FIG. 17 is a functional block diagram according to at least one example of at least one embodiment.

FIG. 18 is a processing flowchart according to at least one example of at least one embodiment.

### DETAILED DESCRIPTION

First, at least one embodiment is described by enumerating contents thereof. A computer program for operating an object within a virtual space about three axes according to at least one embodiment has the following configurations.

(Item 1) A non-transitory computer readable medium for storing instructions for execution by a computer configured to operate an object within a virtual space about three axes. The computer is configured to function as a region allocation unit configured to allocate a first region and a second region to an inside of an operation region. The computer is further configured to function as a command generation unit configured to generate, in response to a first input operation within the first region, a first operation command to operate the object relating to a first axis and a second axis within the virtual space. The command generation unit is further configured to

generate, in response to a second input operation within the second region, a second operation command to operate the object relating to a third axis within the virtual space.

According to this item, a command to operate an object within the virtual space about three axes can be efficiently generated, and a user's intuitive input operation can be implemented when the object within the virtual space is operated about three axes. In particular, a smooth object operation with a high degree of freedom can be implemented. Further, in a 3D game requiring efficient game progression, in particular, the need to perform an operation to input or specify a numerical value can be eliminated.

(Item 2) A non-transitory computer readable medium for storing instructions for execution by a computer according to Item 1,

in which the operation region is a touch region on a touch panel. The first input operation and the second input operation are a first touch operation and a second touch operation on the touch panel, respectively. The computer includes the touch panel.

According to this item, the object within the virtual space can be operated about three axes through the user's touch input operation using one of his or her fingers.

(Item 3) A non-transitory computer readable medium for storing instructions for execution by a computer according to Item 2,

in which the first touch operation and the second touch operation are each a slide operation. The command generation unit is configured to generate the first operation command and the second operation command each including a rotation operation command to rotate the object, the rotation operation command including a rotation amount corresponding to a distance of the slide operation.

According to this item, an intuitive input operation with a high degree of freedom can be implemented through the user's slide operation using one of his or her fingers.

(Item 4) A non-transitory computer readable medium for storing instructions for execution by a computer according to Item 3, in which the command generation unit is configured to generate the second operation command including a rotation operation command to rotate the object relating to a roll angle within the virtual space.

According to this item, a smooth input operation with a higher degree of freedom can be performed by implementing the object rotation operation about the roll angle.

(Item 5) A non-transitory computer readable medium for storing instructions for execution by a computer according to any one of Items 1 to 4, in which the command generation unit is configured to generate the first operation command including a first-axis operation command and a second-axis operation command. The command generation unit is configured to

decompose an operation vector relating to the first input operation into a first component and a second component. The command generation unit is further configured to generate the first-axis operation command based on the first component and generate the second-axis operation command based on the second component.

According to this item, a smooth input operation with a higher degree of freedom can be performed through the decomposition of the operation vector.

(Item 6) A non-transitory computer readable medium for storing instructions for execution by a computer according to any one of Items 1 to 5,

in which the computer includes a mobile terminal. The region allocation unit is configured to, when a state in which a long-axis direction of the mobile terminal is a vertical direction is maintained, allocate the second region to a bottom portion of the operation region such that the second region has a predetermined area ratio.

According to this item, a more user-friendly user input can be implemented by devising the arrangement of the second region.

(Item 7) A non-transitory computer readable medium for storing instructions for execution by a computer according to any one of Items 1 to 6,

in which the computer is a mobile terminal. The region allocation unit is configured to, when a state in which a long-axis direction of the mobile terminal is a horizontal direction is maintained, allocate the second region to one of left and right side portions of the operation region such that the second region has a predetermined area ratio.

According to this item, a more user-friendly user input can be implemented by devising the arrangement of the second region.

(Item 8) A non-transitory computer readable medium for storing instructions for execution by a computer according to any one of Items 1 to 7, further causing the computer to function as

an object operation unit configured to execute, in response to at least one of the first operation command or the second operation command, the at least one of the first operation command or the second operation command to operate the object arranged within the virtual space. The computer is further configured to function as an image generation unit configured to generate a virtual space image in which the object is arranged in order to display the virtual space image on a display unit of the computer.

(Item 9) A non-transitory computer readable medium for storing instructions for execution by a computer according to any one of Items 1 to 7,

in which the computer is connected to a head-mounted display (HMD) system through communication. The HMD system includes

an HMD configured to display a virtual space image in which the object is contained; and an HMD computer connected to the HMD. The HMD computer includes an object operation unit configured to execute, in response to reception, from the computer, of at least one of the first operation command or the second operation command to operate the object, the at least one of the first operation command or the second operation command to operate the object arranged within the virtual space. The HMD computer further includes an image generation unit configured to generate the virtual space image in which the object is arranged in order to display the virtual space image on the HMD.

Now, referring to the accompanying drawings, a description is given of a computer program for operating an object within a virtual space about three axes according to the embodiment of the present invention. In the drawings, like components are denoted by like reference numerals. The computer program for displaying a user interface (UI) image according to the embodiment of the present invention can be applied mainly as a part of a game program that is a 3D game. Further, although not limited thereto, in at least one embodiment a mobile terminal including a touch panel, e.g., a smartphone, is adopted as a user terminal, and the mobile terminal can be used as a controller of the 3D game.

Outline of User Terminal

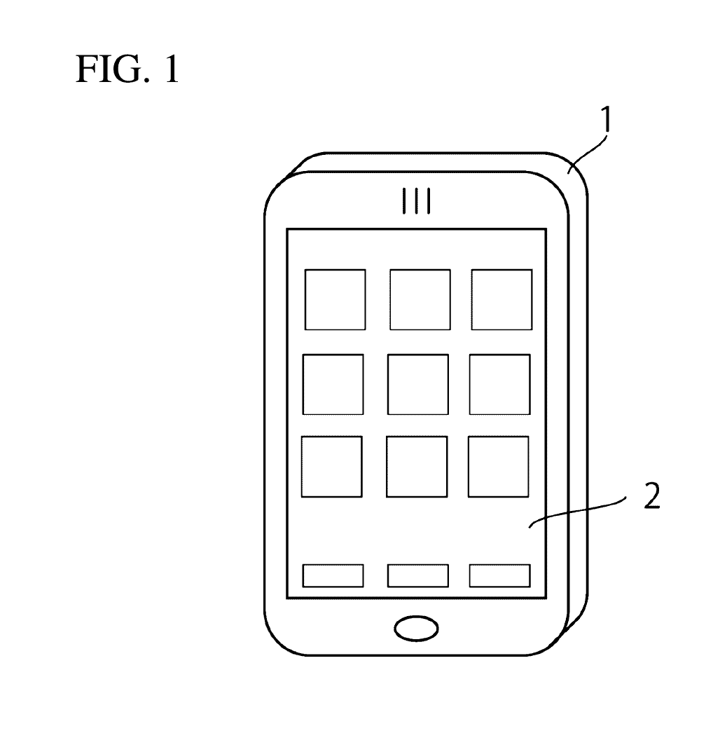

A smartphone 1 illustrated in FIG. 1 is an example of the mobile terminal, and includes a touch panel 2. A user of the smartphone can control an operation of an object through a user operation (e.g., touch operation) on the touch panel 2.

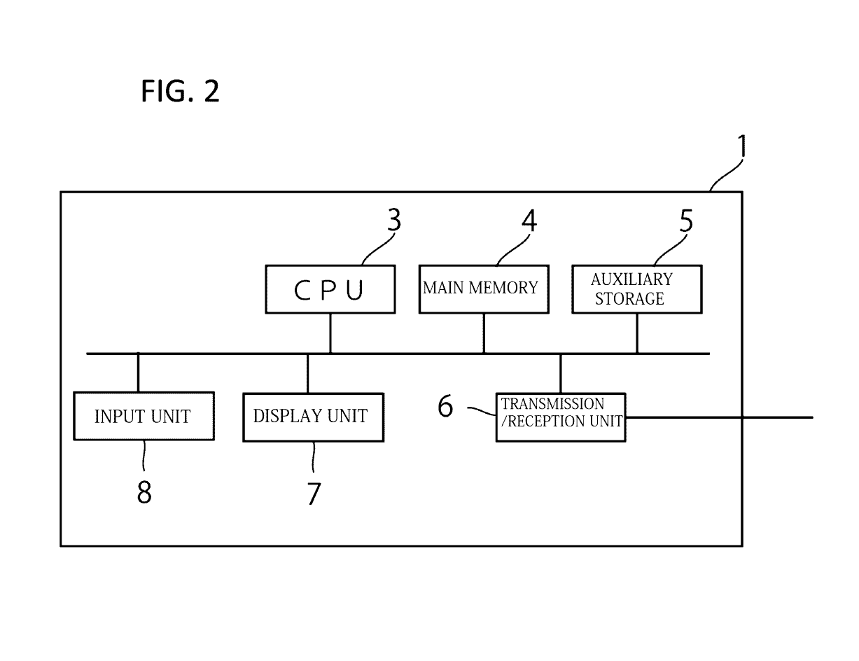

As illustrated in FIG. 2, the user terminal, e.g., the smartphone 1, includes a central processing unit (CPU) 3, a main memory 4, an auxiliary storage 5, a transmission/reception unit 6, a display unit 7, and an input unit 8, which are connected to one another by a bus. Of those components, the main memory 4 is constructed with, for example, a dynamic random-access memory (DRAM), and the auxiliary storage 5 is constructed with, for example, a hard disk drive (HDD). The auxiliary storage 5 is a non-transitory recording medium on which the computer program and the game program according to this embodiment can be recorded. Various programs stored in the auxiliary storage 5 are loaded onto the main memory 4 to be executed by the CPU 3. On the main memory 4, data generated by the CPU 3 while operating in accordance with the computer program according to the embodiment of the present invention and data to be used by the CPU 3 are also temporarily stored. The transmission/reception unit 6 is configured to establish connection (wireless connection and/or wired connection) between the smartphone 1 and a network under the control of the CPU 3 to transmit and receive various types of information. The display unit 7 is configured to display various types of information to be presented to the user under the control of the CPU 3. The input unit 8 is configured to detect the user's input operation, such as a touch input on the touch panel 2. The touch input operation is a physical contact operation, which includes, for example, a tap operation, a flick operation, a slide (swipe) operation, and a hold operation.

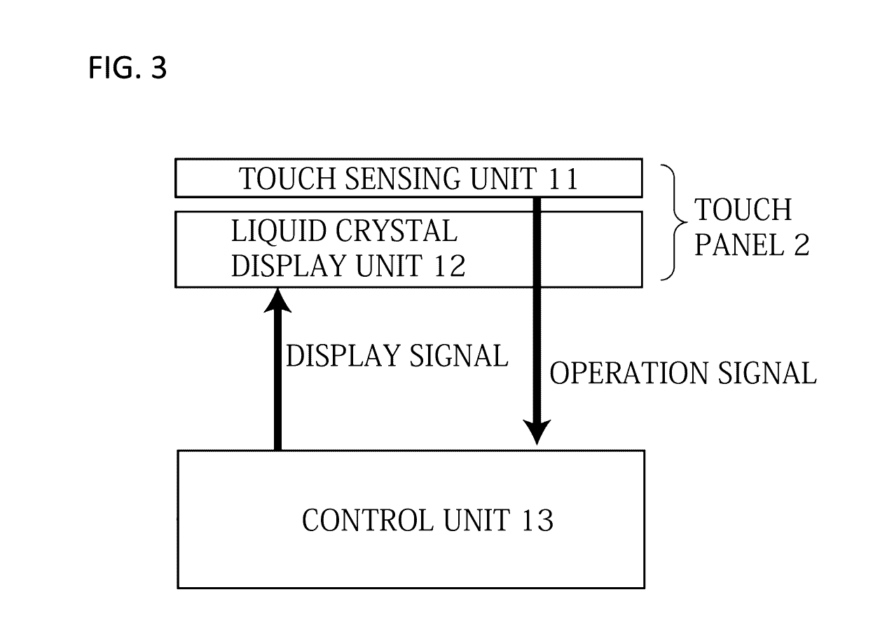

The display unit 7 and the input unit 8 correspond to the above-mentioned touch panel 2. As illustrated in FIG. 3, the touch panel 2 includes a touch sensing unit 11 corresponding to the input unit 8 and a liquid crystal display unit 12 corresponding to the display unit 7. In some embodiments, touch panel 2 includes a different type of display unit, such as a light emitting diode (LED) or organic LED (OLED) display unit. The touch panel 2 is configured to, under the control of the CPU 3, display an image to receive an interactive touch operation performed by the user of the smartphone (e.g., physical contact operation on the touch panel 2). The touch panel 2 is also configured to display on the liquid crystal display unit 12, based on control by a control unit 13, graphics corresponding to the control.

More specifically, the touch sensing unit 11 is configured to output to the control unit 13 an operation signal that is based on the user's touch operation. The touch operation may be performed with any object. For example, the touch operation may be performed with the user's finger, or may be performed through use of a stylus. Further, for example, a capacitive touch sensor may be used as the touch sensing unit 11, but the type of the touch sensing unit 11 is not limited thereto. The control unit 13 is configured to perform the following processing. Specifically, when detecting an operation signal from the touch sensing unit 11, for example, the control unit 13 interprets the operation signal to generate an operation command to operate an object within the three-dimensional virtual space. The control unit 13 then executes the operation command to operate the object, and transmits graphics (not shown) corresponding to the operation command to the liquid crystal display unit as a display signal. The liquid crystal display unit 12 is configured to display the graphics that are based on the display signal. The control unit 13 may be configured to execute only a part of the above-mentioned processing.

As the user terminal for executing the computer program according to at least one embodiment, the smartphone including the touch panel is described above as an example. However, the user terminal is not limited to such a smartphone. In addition to a smartphone, for example, a mobile terminal, e.g., a game console, a personal digital assistant (PDA), or a tablet computer, may be adopted as the user terminal irrespective of whether or not the user terminal includes a touch panel. Further, in addition to a mobile terminal, an arbitrary general-purpose computing device, e.g., a general desktop personal computer (PC), may be adopted as the user terminal.

Generation of Object Operation Command to Operate Object within Virtual Space about Three Axes

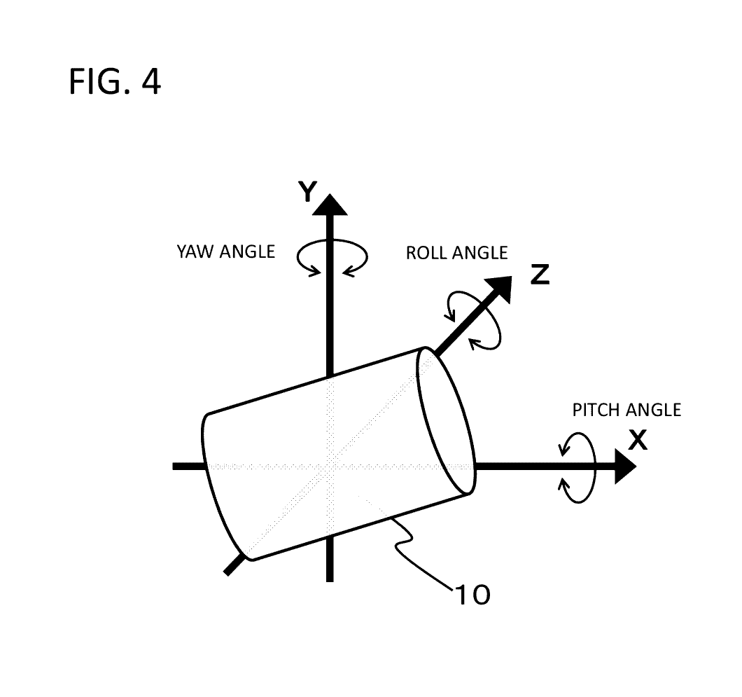

Now, through use of the example of the smartphone 1 illustrated in FIG. 1, as illustrated in FIG. 4, a description is given of an object operation example in which a columnar object is rotated within the three-dimensional virtual space about three axes. In some embodiments, the object has a different shape. As illustrated in FIG. 4, after the user has operated the columnar object 10, the object 10 is arranged at a predetermined position to have inclinations with respect to the three axes of the three-dimensional virtual space. In other words, in the three-dimensional virtual space, the object has angle information and position information relating to its inclinations.

In general, the three-dimensional virtual space can be defined based on an XYZ coordinate system having XYZ axes orthogonal to one another. In the example of FIG. 4, XYZ coordinates are defined with the position of the object 10 being set as an origin. The angle information is defined based on an angle about each of the axes. When a viewpoint is arranged in a negative direction of the Z-axis and a line of sight is defined in a direction of the origin, rotation angles about the X-axis, the Y-axis, and the Z-axis are generally referred to as rotation directions of a pitch angle, a yaw angle, and a roll angle, respectively.

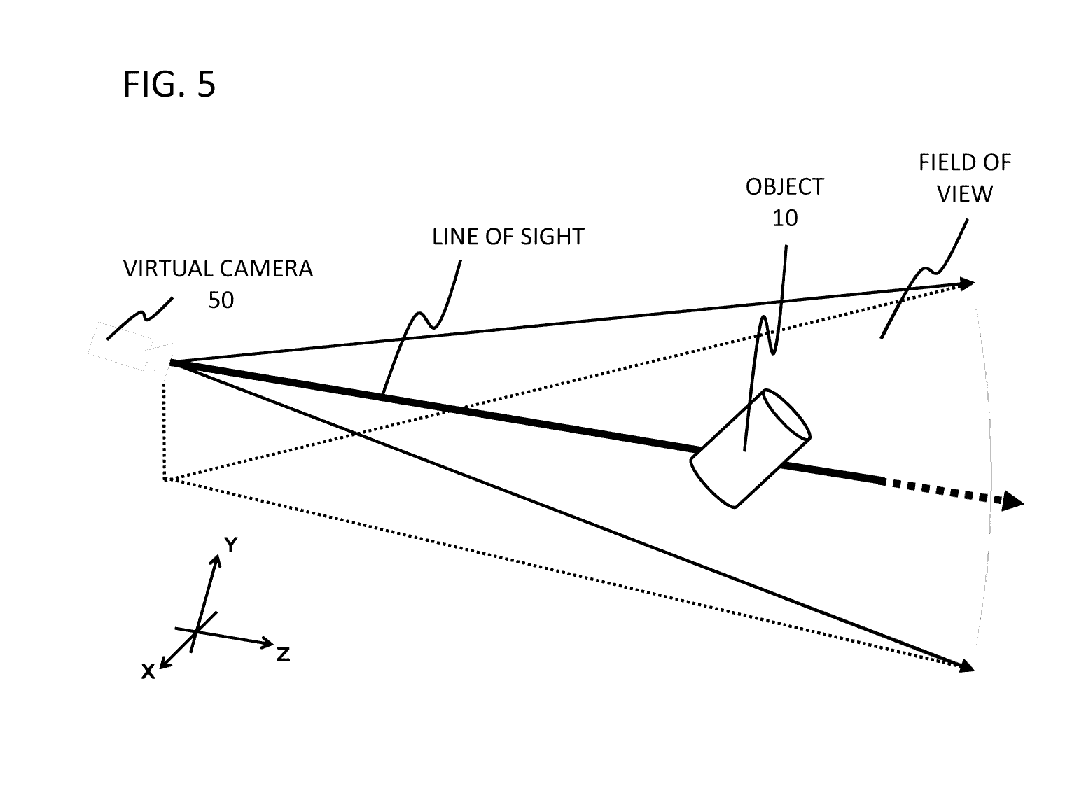

When the columnar object 10 arranged within the three-dimensional virtual space is output to the user, a field-of-view image is generated by a virtual camera and output through the display unit 7 (liquid crystal display unit 12). As illustrated as an example in FIG. 5, a virtual camera 50 is arranged in the three-dimensional virtual space at such a position as to have a predetermined distance and height with respect to the columnar object 10. In this example, the virtual camera is directed such that the columnar object 10 is arranged at the center of a field of view to determine a line of sight and field of view and to generate a three-dimensional virtual space image. In at least one embodiment, the XYZ coordinate system illustrated in FIG. 4 is defined within the three-dimensional space based relatively on the position, the line of sight, and the field of view of the virtual camera.

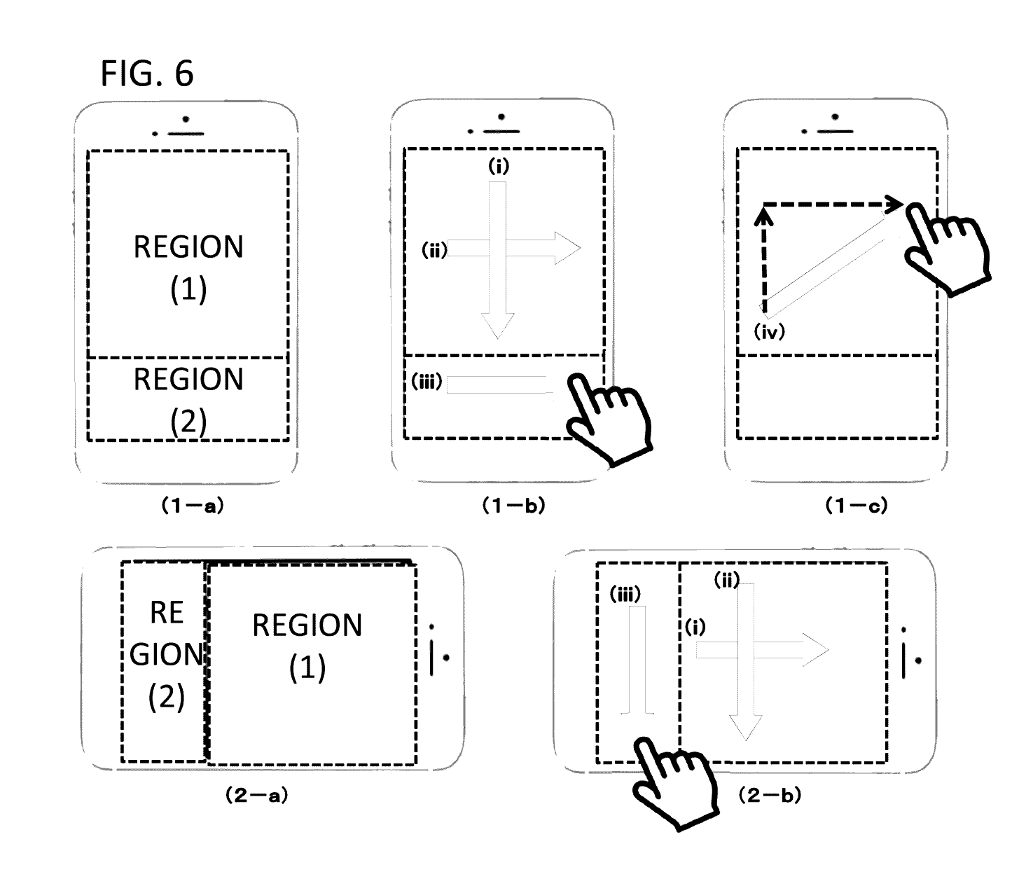

FIG. 6 is an illustration of an operation example for generating an operation command for operating an object within the virtual space about three axes with the user terminal (smartphone) according to at least one embodiment. As illustrated in parts (1-a) and (2-a) of FIG. 6, within an operation region of the smartphone, that is, within a touch region on the touch panel, two rectangular regions, that is, a region (1) and a region (2) are allocated. In some embodiments, the regions have a different shape. Part (1-a) of FIG. 6 is an illustration of a case where the smartphone is held vertically, and part (2-a) of FIG. 6 is an illustration of a case where the smartphone is held horizontally.

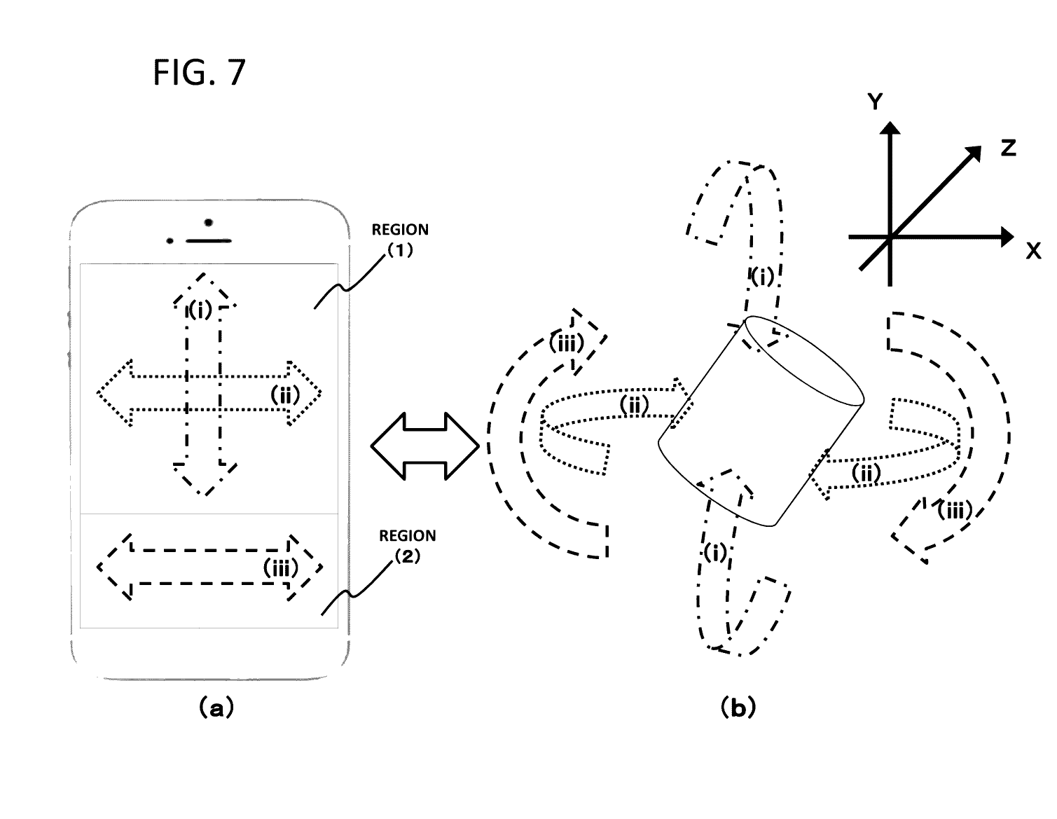

As illustrated in parts (1-a) and (2-a) of FIG. 6, in at least one embodiment, the regions (1) and (2) are formed such that the area occupied by the region (1) is larger than that of the region (2). Further, the region (1) is formed as a region for an operation on the virtual space about two axes (first axis and second axis). The region (2) is formed as a region for an operation on the virtual space about the remaining one axis (third axis). In this manner, the user operation on the touch region can be associated with an operation on the object about three axes within the virtual space. A set of the first axis, the second axis, and the third axis may be associated with, for example, a set of the rotation axes defining the pitch angle, the yaw angle, and the roll angle described above with reference to FIG. 4, through use of any combination of axes. (The association between the axes is described later with reference to FIG. 7.)

In FIG. 6, the touch operation is assumed as a slide operation. As illustrated in part (1-b) of FIG. 6, a slide operation (i) within the region (1) in a vertical direction and a slide operation (ii) within the region (1) in a horizontal direction are associated with object operations about the first axis and the second axis. Further, the slide operation (iii) within the region (2) in the horizontal direction is associated with an object operation about the third axis. As illustrated in part (1-c) of FIG. 6, the slide operation within the region (1) in a diagonal direction is decomposed into a plurality of components as operation vectors. In at least one embodiment, the operation vector having a vertical-direction component and the operation vector having a horizontal-direction component be associated with the object operation about the first axis and the object operation about the second axis, respectively.

The same applies to the case illustrated in part (2-b) of FIG. 6. Specifically, the slide operation (i) within the region (1) in the horizontal direction and the slide operation (ii) within the region (1) in the vertical direction are associated with the object operations about the first axis and the second axis. Further, the slide operation (iii) within the region (2) in the vertical direction is associated with the object operation about the third axis.

In particular, in at least one embodiment, even when an end point of the slide operation is located beyond the region (1) to enter the region (2) as a result of the slide operation within the region (1), the above-mentioned object operation processing is performed without performing exceptional processing. In other words, in at least one embodiment, each region be judged based on a start point of the slide operation (first touch point).

According to at least one embodiment, as illustrated in FIG. 6, an object arranged within the three-dimensional virtual space can be smoothly operated about three axes with the user's slide operation using only one finger. Further, in a 3D game requiring efficient game progression, in particular, the need to perform an operation to input or specify a numerical value can be eliminated. The user only needs to instinctively recognize the region (1) and the region (2), which enables the user's intuitive instruction on the object. In this case, two regions (1) and (2) can be set freely. Specifically, the regions (1) and (2) may be set by a program developer, or may be set by the user himself or herself when the program is started. As another example, the regions (1) and (2) may be changed dynamically in a manner that suits the user's current situation, e.g., depending on whether the smartphone is held vertically (part (1-a) of FIG. 6) or held horizontally (part (2-a) of FIG. 6). The state of part (1-a) of FIG. 6 in which the smartphone is held vertically refers to a state in which a long-axis direction of the mobile terminal is a vertical direction. The state of part (2-a) of FIG. 6 in which the smartphone is held horizontally refers to a state in which the long-axis direction of the mobile terminal is a horizontal direction. In at least one embodiment, when the smartphone is held vertically, the region (2) be allocated to a bottom portion of the touch region so as to have a predetermined area ratio. In at least one embodiment, when the smartphone is held horizontally, the region (2) be allocated to one of left and right side portions of the touch region (left side portion in part (2-a) of FIG. 6) so as to have a predetermined area ratio. The operation within the region (2) is particularly effective as an operation performed by the thumb of the hand holding the smartphone. Further, about 20% is most suitable as the predetermined area ratio between region (1) and region (2), i.e., region (1) area: region (2) area is about 5:1. The arrangement relation between the two regions (1) and (2) is not limited to the one described above, and the regions (1) and (2) may be arranged to be located at any position and to have any shape. Further, the number of regions is not limited to two, and may be three or more.

The smartphone is described as an example in FIG. 6, but embodiments are not limited thereto. Specifically, a wearable terminal including a touch panel, e.g., a watch, or a terminal or a general-purpose computer, e.g., a personal computer (PC), which does not have a touch panel may be adopted as the user terminal. For example, a general desktop PC installed indoors is assumed as the user terminal. In this case, a display region of the display serves as an operation region. In other words, at least two regions (region (1) and region (2)) are allocated to the display region of the display. The user performs a drag operation through use of a mouse to operate an object. In other words, in response to the user's drag operation using the mouse, in the region (1), the object may be operated about the first axis and the second axis of the virtual space, and in the region (2), the object may be operated about the third axis of the virtual space.

Referring to FIG. 7, a description is given of the association between each of the slide operations within the region (1) and the region (2) in the example of the smartphone illustrated in FIG. 6 and each of three axes of the three-dimensional virtual space for an object operation. As an example, the slide operation (i) within the region (1) in the vertical direction is associated with the X-axis, and the slide operation (ii) within the region (1) in the horizontal direction is associated with the Y-axis. Further, the slide operation (iii) within the region (2) in the horizontal direction is associated with the Z-axis. As described above with reference to FIG. 4, when the object operation is a rotation operation, the X-, Y-, and Z-axes correspond to the rotation directions of the pitch angle, the yaw angle, and the roll angle, respectively, assuming that the viewpoint is in the negative direction of the Z-axis. The association between each of the slide operations and each of the axes is merely an example, and any combination of axes may be employed. According to an experiment conducted by the inventor(s), the inventor(s) found that associating the slide operation (i) within the region (1) in the vertical direction with the object operation in the pitch angle direction about the X-axis suits the user's feeling. Similarly, in at least one embodiment, the slide operation (ii) within the region (1) in the horizontal direction be associated with the object operation in the yaw angle direction about the Y-axis. Further, in at least one embodiment, the slide operation (iii) within the region (2) in the horizontal direction be as sociated with the object operation in the roll angle direction about the Z-axis. In this case, in at least one embodiment, setting of the association between the slide operation (ii) within the region (1) in the horizontal direction and the Y-axis and the association between the slide operation (iii) within the region (2) in the horizontal direction and the Z-axis may be changed based on the user's preference.

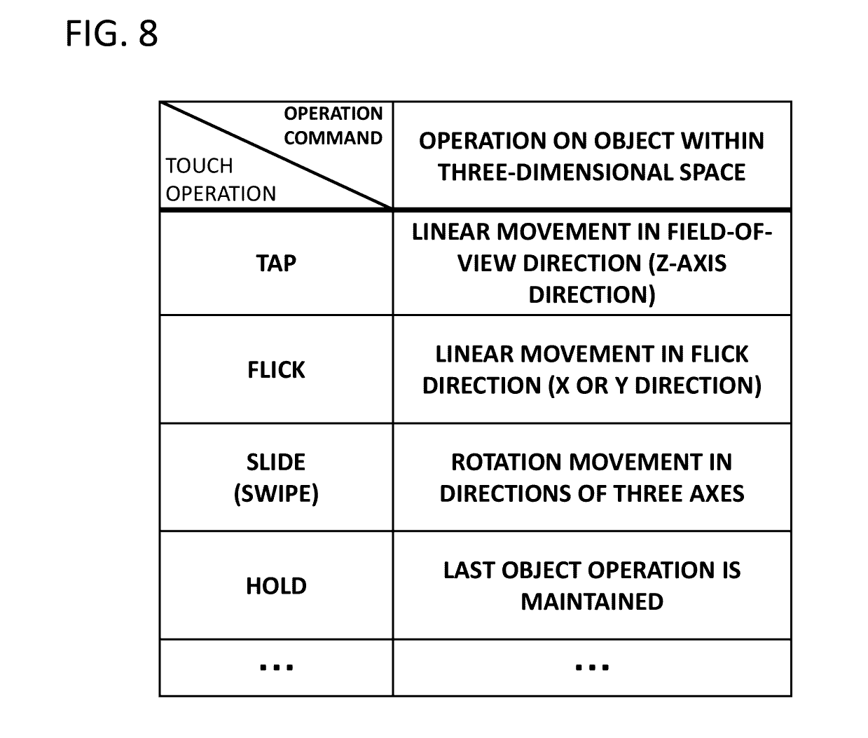

Referring to FIG. 8, a description is given of the association between the type of object operation and the operation of the user terminal. In this case, the touch operation performed when the user terminal includes the touch panel is assumed as the operation of the user terminal. The touch panel is configured to detect a touch start position, a touch end position, an operation direction, operation acceleration, and others. A tap operation, a flick operation, a slide (swipe) operation, a hold operation, and other such operations may be included as the touch operation based on those parameters. Further, based on a characteristic of the type of each touch operation, the touch operation may be associated with an object operation within the three-dimensional space. For example, as shown in FIG. 8, in at least one embodiment, the movement of an object in the field-of-view direction (i.e., enlargement/reduction processing) is associated with the tap operation. In at least one embodiment, a linear movement of the object based on a direction (in particular, X or Y direction) and speed of the flick operation be associated with the flick operation. Further, rotation processing in the directions of three axes based on the distance of the slide operation (refer also to FIG. 7) is performed for the slide operation, and the last object operation is maintained for the hold operation. In at least one embodiment, those associations be stored in a memory as an association table. The above-mentioned association between the type of object operation and the operation of the user terminal is merely an example, and the association is not limited thereto.

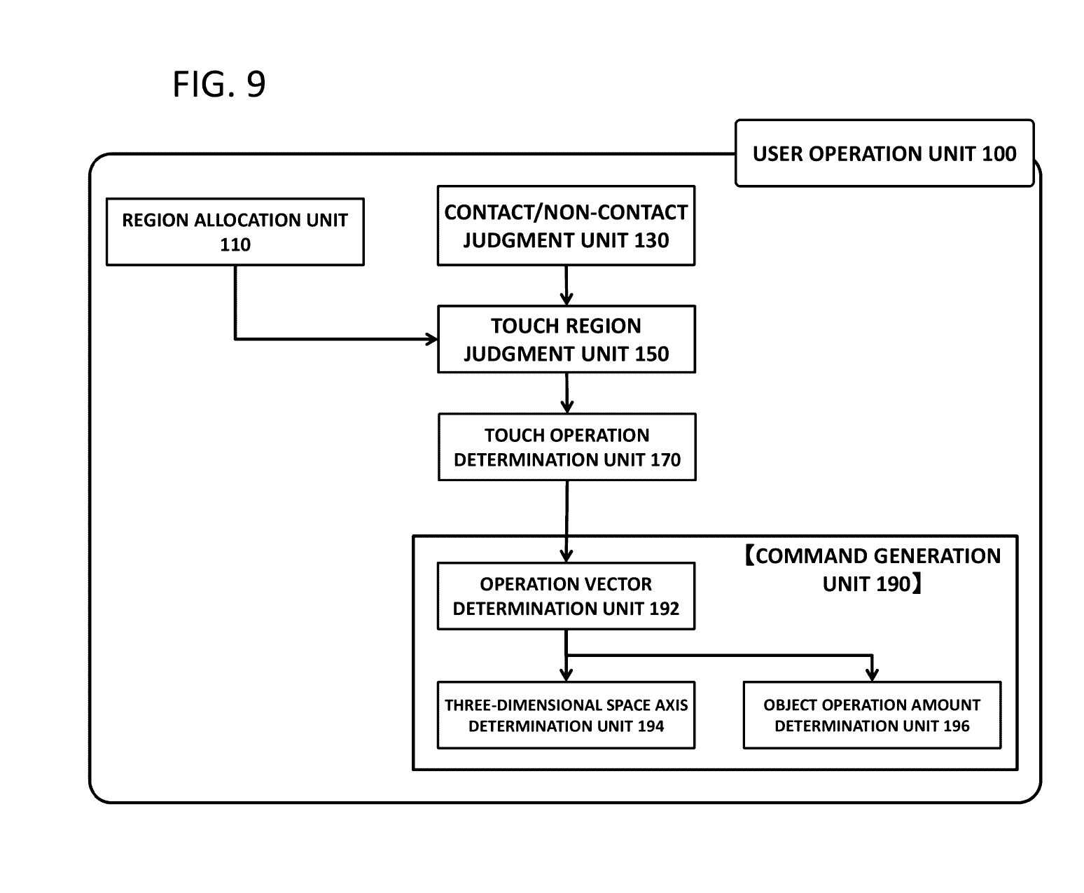

Next, referring to FIG. 9 to FIG. 11, a description is given of information processing for generating, by the computer program according to at least one embodiment, an operation command for operating an object within the three-dimensional virtual space about three axes. In the following, the smartphone including the touch panel is assumed as the user terminal, but the user terminal is not limited thereto.

FIG. 9 is a block diagram for illustrating a main function set for causing the smartphone to perform the information processing. The smartphone is caused to function as a user operation unit 100 configured to generate an object operation command in response to the user's input operation performed through the touch panel. The user operation unit 100 includes a region allocation unit 110 configured to allocate regions, e.g., the region (1) and the region (2) of FIG. 6, a contact/non-contact judgment unit 130 configured to judge whether or not a touch operation or a release operation is performed on the touch panel, a touch region judgment unit 150 configured to judge a region based on the position of a touch operation, a touch operation determination unit 170 configured to judge the type of touch operation, e.g., the slide operation, and a command generation unit 190 configured to generate the object operation command.

The command generation unit 190 includes an operation vector determination unit 192 configured to determine a slide operation vector (i.e., slide operation direction and slide operation distance) when the touch operation determination unit 170 judges that the touch operation is the slide operation, a three-dimensional space axis determination unit 194 configured to associate components of the slide operation vector with the axes of the three-dimensional space, and an object operation amount determination unit 196 configured to determine an object operation amount within the three-dimensional space.

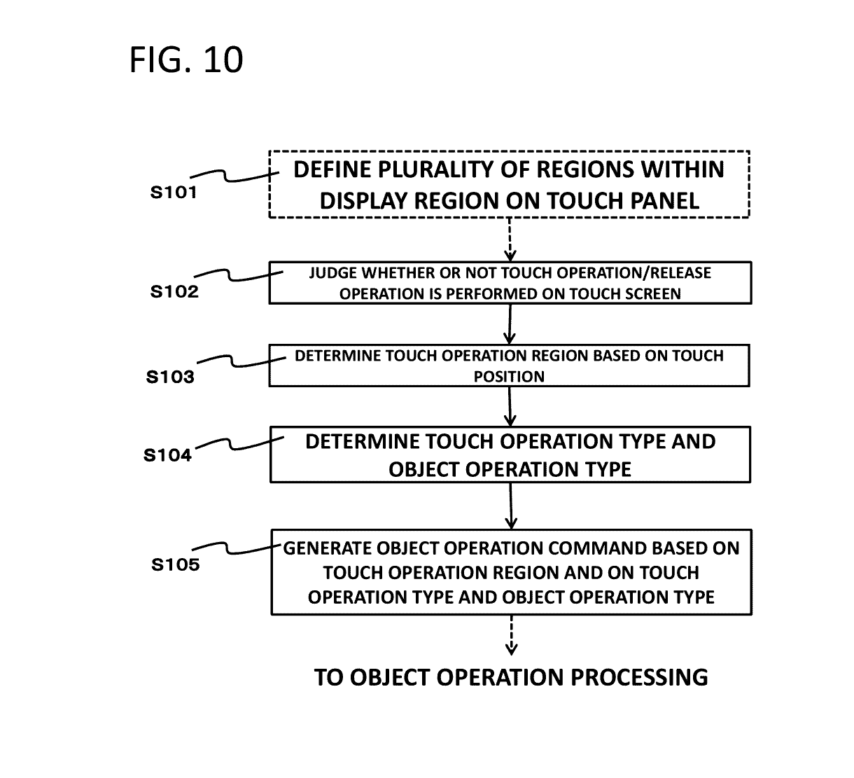

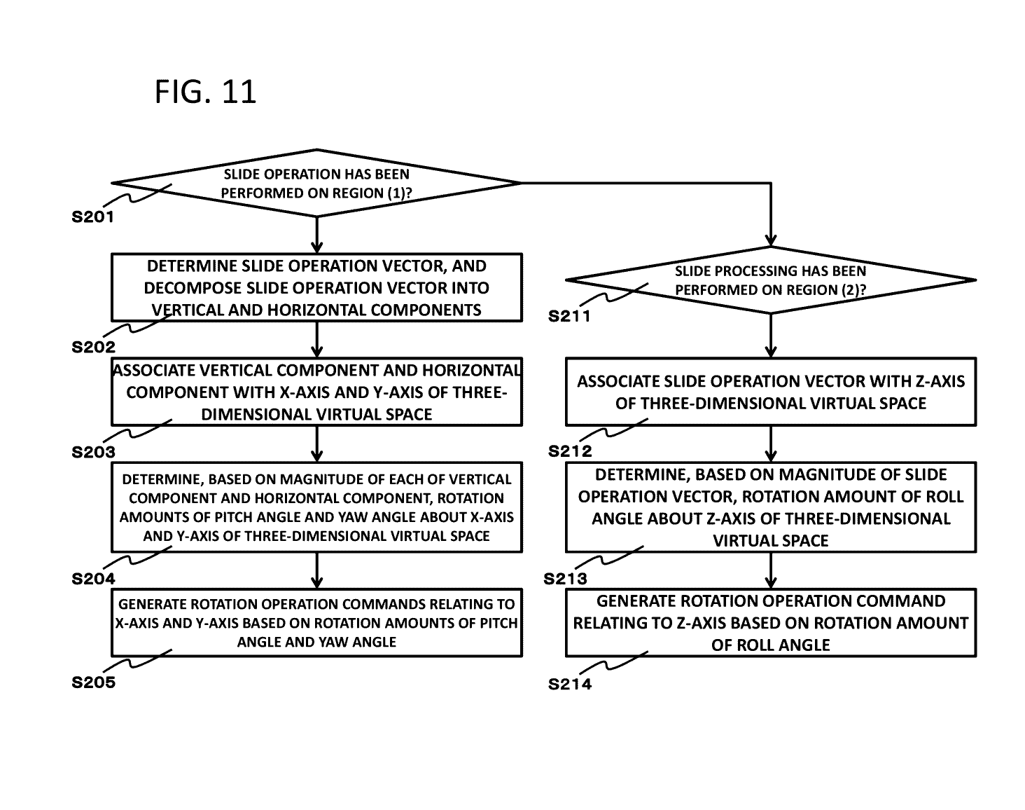

Through use of the above-mentioned set of functional blocks, information processing illustrated in the flowcharts of FIG. 10 and FIG. 11 is performed. In FIG. 10, in Step S101, the region allocation unit 110 allocates the region (1) and the region (2) to the inside of the operation region (touch region on the touch panel) (refer also to parts (1-a) and (2-a) of FIG. 6). This operation only needs to be set when the program is executed. For example, the operation may be set by a program developer when the program is developed, or may be set by the user at the time of initial setting. In Step S102, the contact/non-contact judgment unit 130 performs processing of judging whether or not one or more touch operations/release operations are performed on a touch screen and judging a touch state and a touch position. Then, when it is judged in Step S102 that the touch operation is performed, the processing proceeds to the next Step S103 and the subsequent steps.

In Step S103, the touch region judgment unit 150 judges whether the touch operation judged to be performed in Step S102 is performed within the region (1) or within the region (2). When the touch operation is the slide operation, a case is conceivable in which the start point and the end point of the slide operation are located in different regions. In at least one embodiment, the region is judged based only on the start point of the slide operation. In other words, in at least one embodiment, a slide operation entering another region is allowable.

In Step S104, the touch operation determination unit 170 determines a touch operation type and an object operation type corresponding thereto. As shown in FIG. 8, the touch operation types include, although not limited to, the tap operation, the flick operation, the slide (swipe) operation, the hold operation, and other such operations. For example, when the contact/non-contact judgment unit 130 judges a touch point and a release point in Step S102, the touch operation determination unit 170 determines the touch operation type by determining that the relevant touch operation is the slide operation. Further, when the touch operation type is determined, the touch operation determination unit 170 can also determine the object operation type based on the association table of FIG. 8 stored in the memory. The object operation types include, although not limited to, the linear movement, the rotation movement, the maintenance of a movement state, and other such operations.

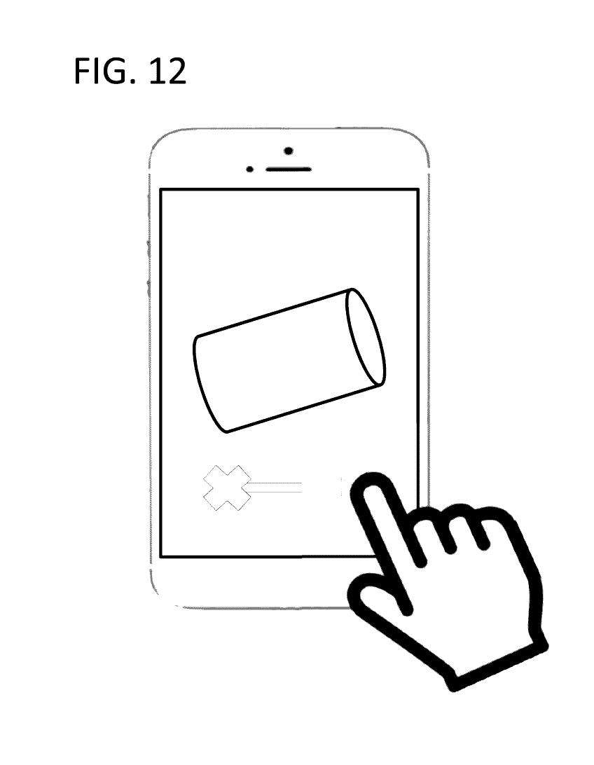

When the touch operation region is judged in Step S103 and the touch operation type and the object operation type are determined in Step S104, the processing proceeds to Step S105. In Step S105, the command generation unit 190 generates an object operation command corresponding to the touch operation. As described below in detail with reference to FIG. 11, for example, for the touch operation within the region (1) of FIG. 6, the object operation command relating to the first axis and the second axis within the three-dimensional virtual space is generated. Similarly, for the touch operation within the region (2) of FIG. 6, the object operation command relating to the third axis within the three-dimensional virtual space is generated. Object operation processing within the three-dimensional virtual space, which is described in at least one example of at least one embodiment illustrated in FIG. 12 and the subsequent figures, is performed based on the object operation commands thus generated.

FIG. 11 is a flowchart for illustrating in detail the object operation command generation processing of Step S105 of FIG. 10. In this processing, the slide operation is assumed as the touch operation, and the rotation operation is assumed as the corresponding object operation. As described above in regard to the outline with reference to FIG. 6, the processing of generating the object operation command branches depending on whether slide processing has been performed within the region (1) (S201) or within the region (2) (S211).

A case is described where the slide operation has been performed within the region (1) (refer also to part (1-c) of FIG. 6). In Step S202, the operation vector determination unit 192 determines the operation vector of the slide operation. Specifically, the direction and distance of the slide operation are determined. Further, the slide operation vector is decomposed into components of the vertical and horizontal directions of the touch panel. Then, each of the components is associated with one of two axes of the three-dimensional space, and the two object operation commands associated with those axes are generated.

Specifically, in Step S203, the three-dimensional space axis determination unit 194 associates the vertical component and the horizontal component with the X-axis and the Y-axis of the three-dimensional virtual space (refer also to FIG. 4). Then, in Step S204, the object operation amount determination unit 196 determines, based on the magnitude of each of the vertical component and the horizontal component (i.e., distance of the slide operation for each component), rotation amounts of the pitch angle and the yaw angle about the X-axis and the Y-axis of the three-dimensional virtual space. In Step S205, the command generation unit 190 generates rotation operation commands relating to the X- and Y-axes based on the rotation amounts in the pitch angle direction and the yaw angle direction. Specifically, the rotation operation command relating to the X-axis is generated based on the vertical component, and the rotation operation command relating to the Y-axis is generated based on the horizontal component.

The processing then returns to Step S211, and when the slide operation has been performed within the region (2), the processing proceeds to Step S212. In Step S212, the three-dimensional space axis determination unit 194 associates the slide operation vector with the Z-axis of the three-dimensional virtual space (refer also to FIG. 4). Then, in Step S213, the object operation amount determination unit 196 determines, based on the magnitude of the slide operation vector (i.e., distance of the slide operation), the rotation amount of the roll angle about the Z-axis of the three-dimensional virtual space. In Step S214, the command generation unit 190 generates a rotation operation command relating to the Z-axis based on the rotation amount in the roll angle direction. Also when the slide operation is performed within the region (2), in the same manner as in the region (1), the slide operation vector may be decomposed into a vertical component and a horizontal component to determine the rotation amount of the roll angle through use of only the horizontal component.

In at least one embodiment, the rotation amount of an object to be rotated within the three-dimensional virtual space be determined based on the distance of the slide operation as described above, but a method of determining the rotation amount is not limited thereto. As another example, the speed and acceleration of the slide operation may be measured to be reflected in the rotation amount. Further, for example, those parameters may be used for calculation of a rotation speed in addition to the rotation amount.

Execution of Object Operation Command and Output of Three-Dimensional Virtual Space Image

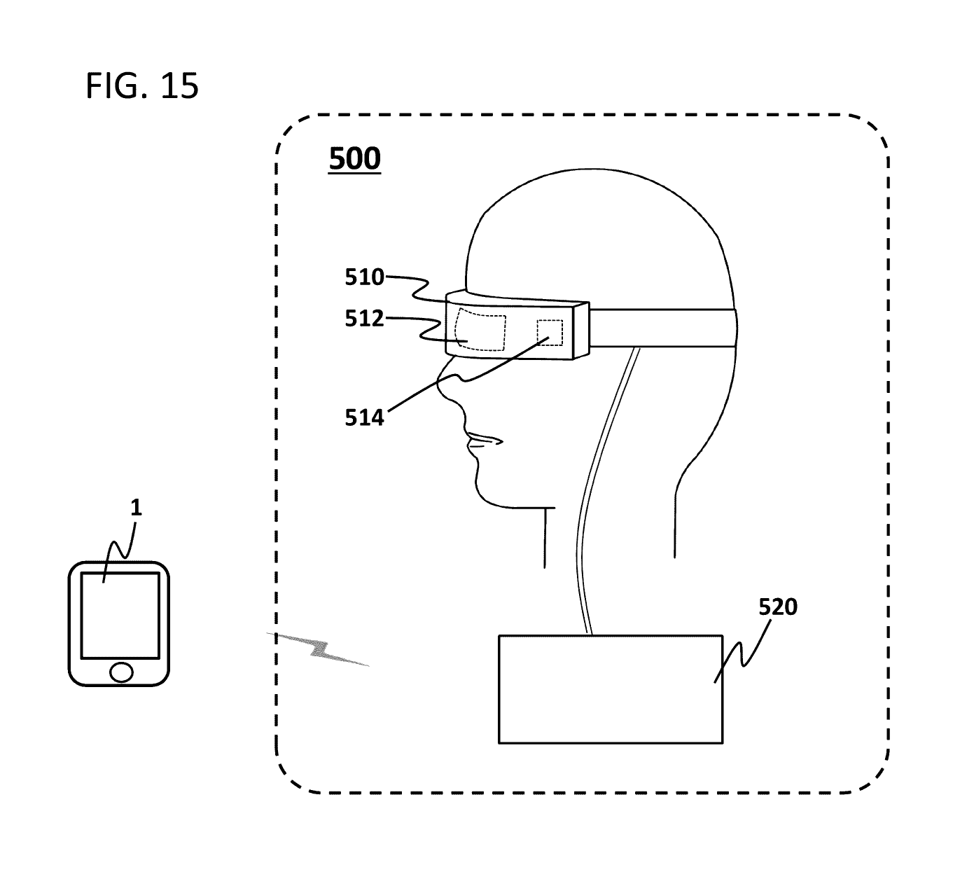

The object operation command that has been generated through the processing of FIG. 11 and the previous figures may be executed by various computers as described below with reference to examples illustrated in FIG. 12 and the subsequent figures. This computer may be the same as a computer that has received the user operation to generate the object operation command, or may be a different computer. FIG. 12 to FIG. 14 are illustrations of at least one example of at least one embodiment, in which a computer that has received the user operation to generate the object operation command continuously executes and displays the object operation command. Meanwhile, FIG. 15 to FIG. 18 are illustrations of at least one example of at least one embodiment, in which a computer different from the computer that has received the user operation to generate the object operation command receives the object operation command to execute and display the object operation command.

FIG. 12 is a conceptual diagram of at least one example, in which the smartphone including the touch panel continuously executes and displays the object operation command after generating the object operation command. In at least one example, the user's slide operation and objection rotation operation are performed in an interactive manner through the same touch panel. In other words, the user only needs to adjust the rotation amount by intuitively performing the slide operation as necessary while looking at the touch panel, and hence a smooth object operation with a high degree of freedom can be implemented. Meanwhile, when a general PC is adopted as the user terminal instead of the smartphone, the user looks at a display while operating a mouse. Even in this case, by intuitively performing a drag operation while looking at a mouse cursor displayed on the display, the user adjusts the rotation amount of the object displayed on the same display. In this respect, a smooth object operation with a high degree of freedom can be implemented even in this case.

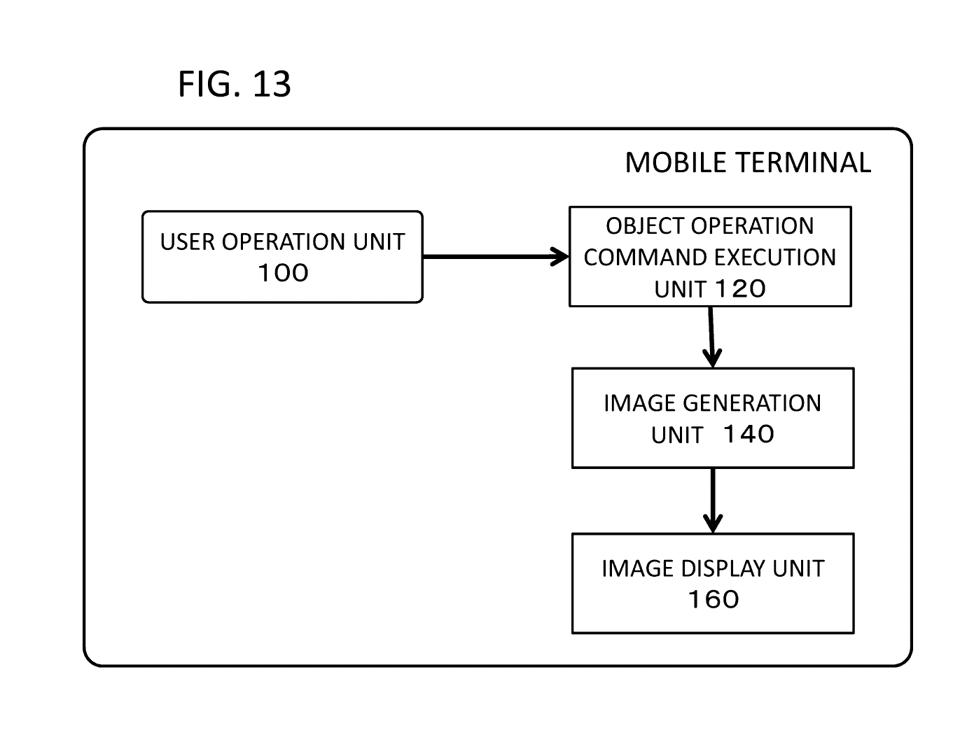

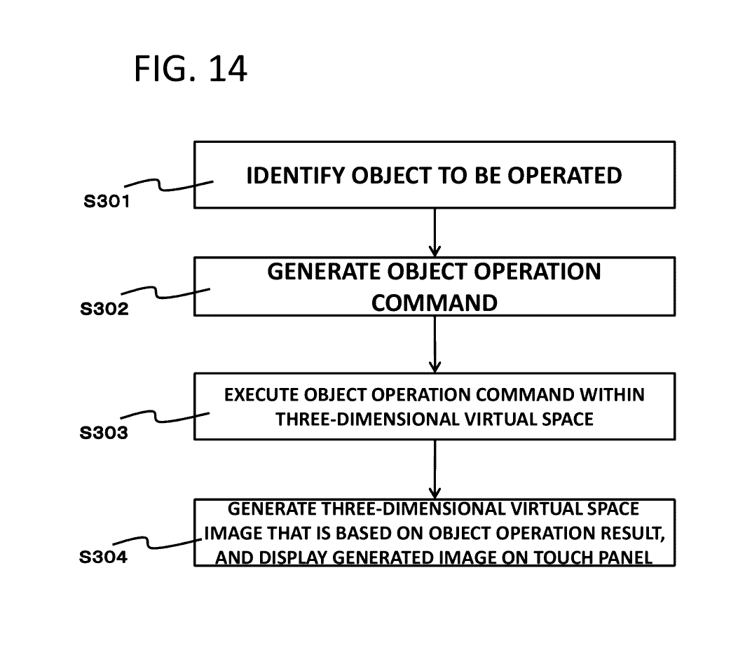

In at least one example, as illustrated in subsequent FIG. 13, the user terminal functions so as to include, as its main functional blocks, in addition to the user operation unit 100 described above with reference to FIG. 9, an object operation command execution unit 120 configured to execute an object operation command, an image generation unit 140 configured to generate a three-dimensional virtual space image, and an image display unit 160 configured to display the three-dimensional virtual space image. In at least one example, the user terminal uses the functional blocks illustrated in FIG. 13 to execute information processing that is based on a flowchart of FIG. 14. Further, in order to operate an object, an object to be operated needs to be identified first as in Step S301. As an example of a mode for identifying an object, in at least one embodiment, the following mode is assumed: the user selects a specific object from among a plurality of objects within the three-dimensional virtual space through the touch operation. In at least one embodiment, any mode may be adopted as the mode for identifying an object.

When the object to be operated is identified in Step S301, in Step S302, the user's input operation is received to generate the object operation command described above with reference to FIG. 11 and the previous figures. In response to this, in Step S303, the object operation command execution unit 120 executes the object operation command. Specifically, the object operation command execution unit 120 receives the operation command to operate the region (1) and/or the operation command to operate the region (2) and executes the received operation command(s), to thereby operate the object arranged within the three-dimensional virtual space. In Step S304, the image generation unit 140 generates the three-dimensional virtual space image that is based on an object operation result, and the image display unit 160 performs processing of outputting the generated image to display the image on the touch panel.

Next, a description is given of at least one example in which an HMD system including a computer different from the computer that has generated the object operation command executes the object operation command to display a three-dimensional virtual space image on an HMD. First, referring to FIG. 15, an overall outline of an HMD system 500 to be used in this Example is described. As illustrated in FIG. 15, the HMD system 500 includes an HMD body 510 configured to display the virtual space image in which an object is contained and an HMD computer 520 connected to the HMD body 510 and configured to execute an object operation command. The HMD computer 520 may be constructed with a general-purpose computer. The HMD system 500 is connected through communication to the user terminal 1, e.g., a smartphone, which is configured to receive the user operation to generate the object operation command.

The HMD body 510 includes a display 512 and a sensor 514. The display 512 may be, as an example, a non-transparent display device constructed so as to completely cover the user's field of view, and the user can view only a screen displayed on the display 512. In some embodiments, display 512 is a partially transmissive display device. Further, in at least one embodiment, the user wearing the non-transparent HMD body 510 loses their entire field of view outside of the HMD, and hence a display mode is such that the user is completely immersed in the virtual space displayed by an application executed by the HMD computer 520. The sensor 514 included in the HMD body 510 is fixed near the display 512. The sensor 514 includes a geomagnetic sensor, an acceleration sensor, and/or an inclination (angular velocity, gyro) sensor, and can detect various movements of the HMD body 510 (display 112) worn on the user's head through one or more of those sensors.

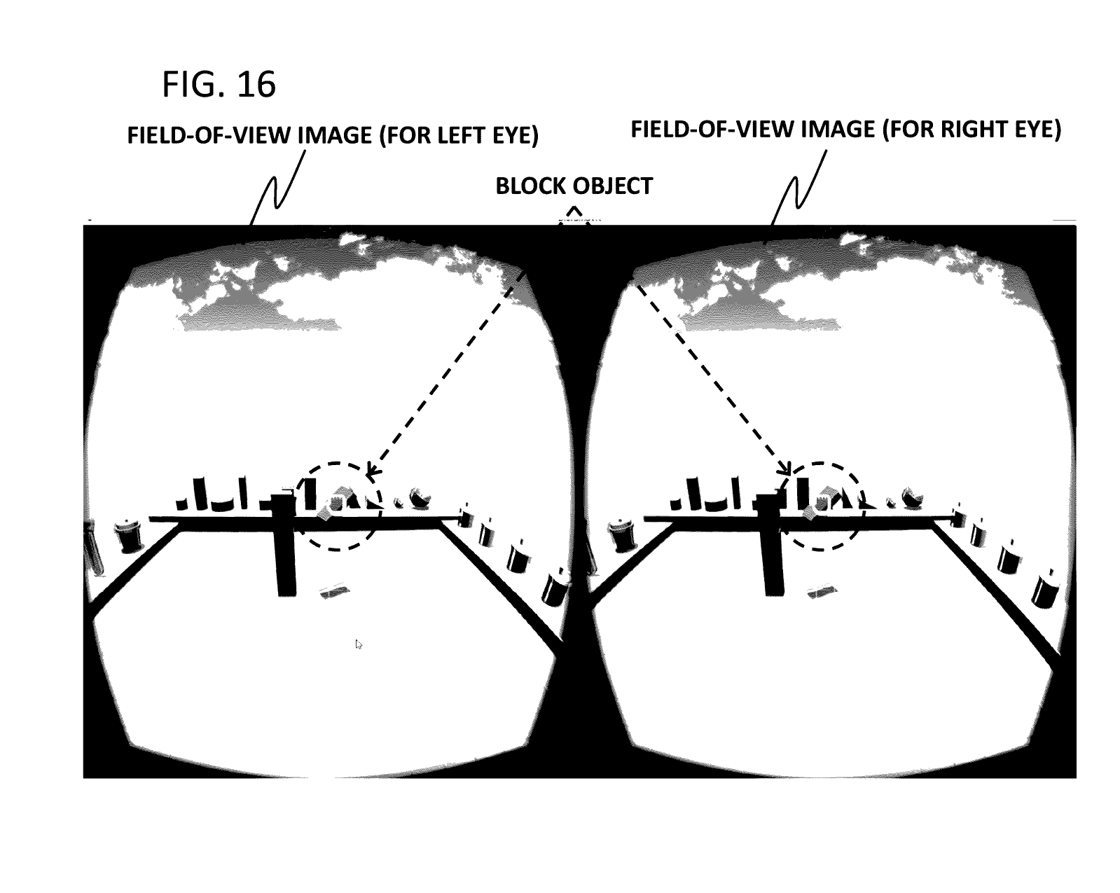

FIG. 16 is a conceptual diagram of a case where the HMD system 500 communicates to/from the mobile terminal 1 to receive an object operation command and executes and displays the object operation command. The HMD computer 520 generates two-dimensional images as field-of-view images in such a manner as to shift two images for a left eye and a right eye from each other. The user sees those two images that are superimposed on one another through the HMD body 510. Thus, the two-dimensional images are displayed on the HMD body 510 such that the user feels as if the user is seeing a three-dimensional image. In the screen image of FIG. 16, a virtual camera is set such that a “block object” is arranged in the middle of the screen. The user can tilt the “block object” at a given angle while performing the touch operation on the mobile terminal (refer also to FIG. 5).

In at least one example, the user wearing the HMD to be immersed in the three-dimensional virtual space operates an object displayed on the HMD while intuitively performing the touch operation without looking at the touch panel operated by himself or herself. However, with the computer program for operating an object within a virtual space about three axes according to at least one embodiment, the user only needs to instinctively recognize the region (1) and the region (2) to adjust the rotation amount through a simple and appropriate touch operation. Therefore, a smooth object operation that is high in degree of freedom and intuitive for the user can be performed.

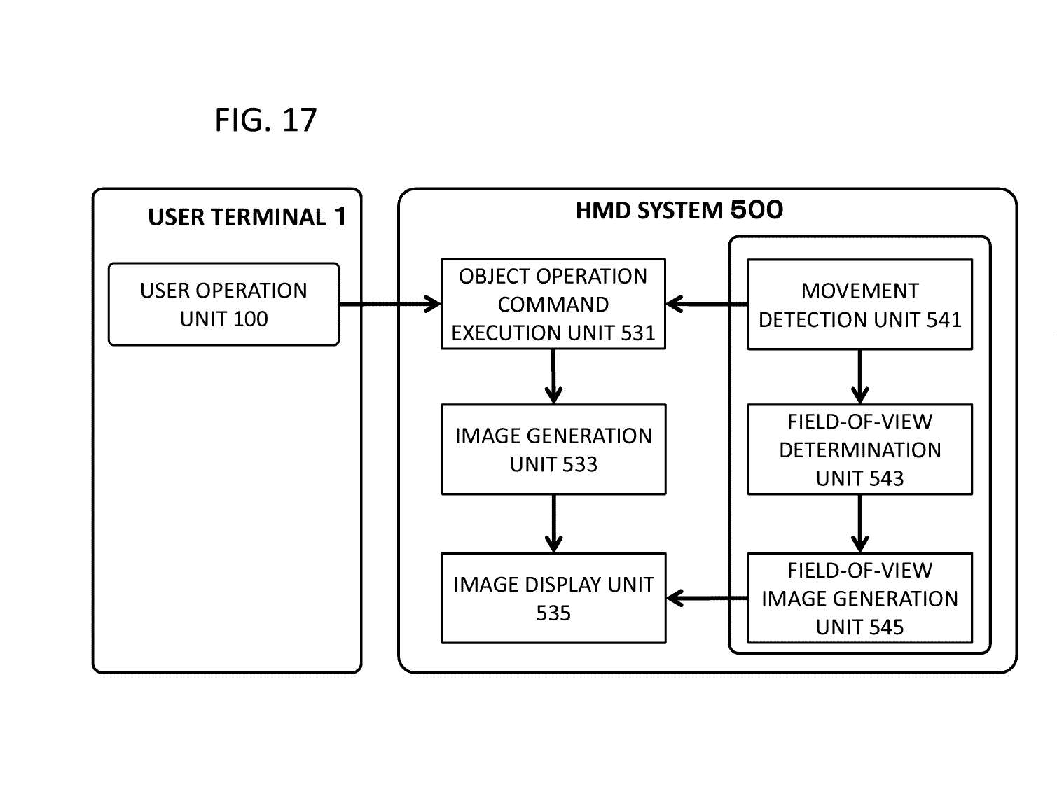

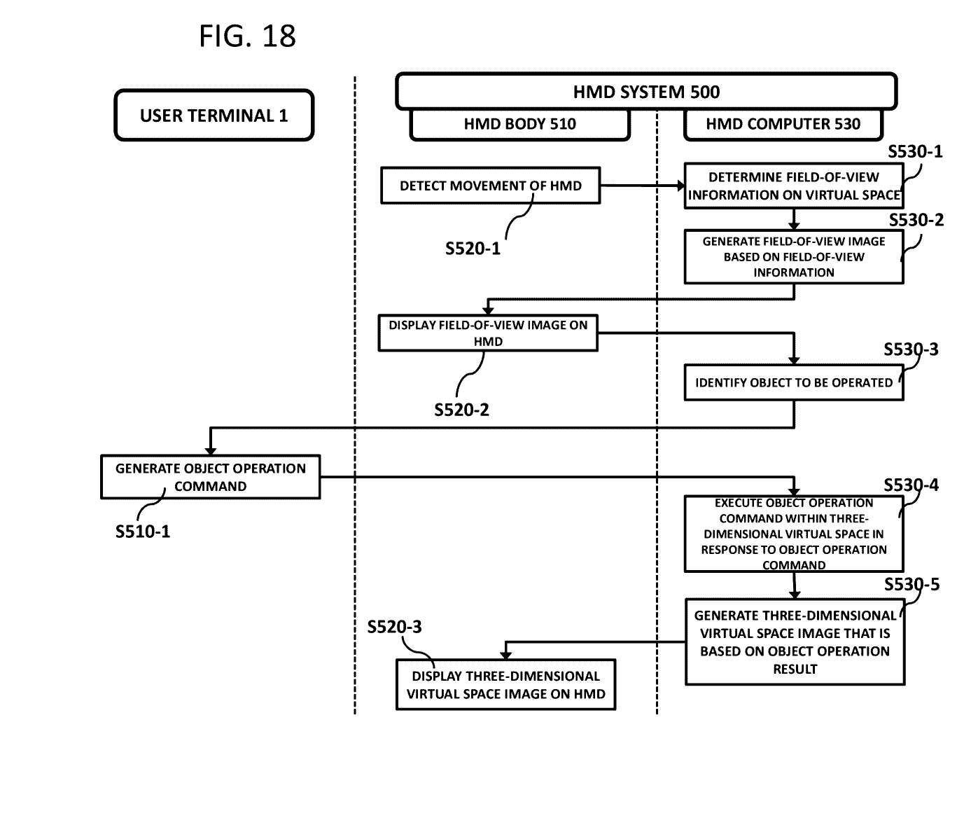

In at least one example, as illustrated in FIG. 17, the user terminal 1 functions as the user operation unit 100 described above with reference to FIG. 9. Meanwhile, the HMD system 500 functions so as to include, as its main functional blocks, an object operation command execution unit 531 configured to execute an object operation command, an image generation unit 533 configured to generate a three-dimensional virtual space image, and an image display unit 535 configured to display the three-dimensional virtual space image. The HMD system 500 also functions as a movement detection unit 541 configured to detect the movement of the user wearing the HMD, a field-of-view determination unit 543 configured to determine a field of view from the virtual camera, and a field-of-view image generation unit 545 configured to generate an image of the entire three-dimensional space. In at least one example, the mobile terminal 1 uses the functional blocks illustrated in FIG. 17 to execute information processing that is based on the flowchart of FIG. 18. This information processing is executed while the user terminal 1 and the HMD system 500 are interacting with each other through communication therebetween.

In Step S520-1, the movement detection unit 541 uses the sensor mounted in the HMD body 510 to detect the movement of the HMD (e.g., inclination). In response to this, in Step S530-1, the field-of-view determination unit 543 of the HMD computer 530 determines field-of-view information on the virtual space. Further, in Step S530-2, the field-of-view image generation unit 545 generates a field-of-view image based on the field-of-view information (refer also to FIG. 5). In Step S520-2, the field-of-view image is output through the HMD body 510 based on the generated field-of-view image. When the user wearing the HMD performs an action, e.g., tilting his or her head, in Step S530-3, the HMD body 510 identifies the object to be operated. In at least one embodiment, a mode for identifying an object is not limited to the above-mentioned mode that is based on the HMD action, and any mode may be adopted.

When the object to be operated is identified in Step S530-3, in Step S510-1, the user's input operation is received to generate an object operation command described above with reference to FIG. 11 and the previous figures. In response to this, in Step S530-4, the object operation command execution unit 531 of the HMD computer 520 executes the object operation command within the three-dimensional virtual space. Specifically, the object operation command execution unit 531 receives an operation command within the region (1) and/or an operation command within the region (2), and executes the received operation command(s) to operate the object arranged within the three-dimensional virtual space. In Step S530-5, the image generation unit 533 generates a three-dimensional virtual space image that is based on an object operation result. At this time, the image generation unit 533 superimposes the three-dimensional virtual space image from the field-of-view image generation unit 545 onto an image of the object to be operated to generate an entire three-dimensional virtual space image. In Step S520-3, the image display unit 535 performs processing of outputting the entire three-dimensional virtual space image, and this image is displayed on the HMD body 510.

With the computer program for operating an object within a virtual space about three axes according to at least one embodiment, a command to operate an object within the virtual space about three axes can be efficiently generated. When an object within the virtual space is operated about three axes, the user's intuitive input operation can be implemented. In particular, a smooth object operation with a high degree of freedom can be implemented. Further, in a 3D game requiring efficient game progression, in particular, the need to input or specify a numerical value can be eliminated.

In the above, the computer program for operating an object within a virtual space about three axes according to at least one embodiment has been described along with several examples. The above-mentioned at least one embodiment is merely an example for facilitating an understanding of the present description, and does not serve to limit an interpretation of the present description. It should be understood that the present description can be changed and modified without departing from the gist of the description, and that the present description includes equivalents thereof.

What is claimed is:

1. A system comprising:
a non-transitory computer readable medium configured to store instructions for operating an object within a virtual space about three axes; and
a computer connected to the non-transitory computer readable medium, wherein the computer is configured to execute the instructions for causing the computer to function as:
a region allocation unit configured to allocate a first region and a second region to an inside of an operation region; and
a command generation unit configured to:
generate, in response to a first input operation within the first region, a first operation command to operate the object relating to a first axis and a second axis within the virtual space; and
generate, in response to a second input operation within the second region, a second operation command to operate the object relating to a third axis within the virtual space.

2. A system according to claim 1,
wherein the operation region comprises a touch region on a touch panel,
wherein the first input operation and the second input operation comprise a first touch operation on the touch panel and a second touch operation on the touch panel, respectively, and
wherein the computer comprises the touch panel.

3. A system according to claim 2,
wherein the first touch operation and the second touch operation each comprise a slide operation, and
wherein the command generation unit is further configured to generate the first operation command and the second operation command each comprising a rotation operation command to rotate the object, the rotation operation command including a rotation amount corresponding to a distance of the slide operation.

4. A system according to claim 3, wherein the command generation unit is further configured to generate the second operation command comprising a rotation operation command to rotate the object relating to a roll angle within the virtual space.

5. A system according to claim 1, wherein the command generation unit is further configured to:
generate the first operation command comprising a first-axis operation command and a second-axis operation command;
decompose an operation vector relating to the first input operation into a first component and a second component; and
generate the first-axis operation command based on the first component and generate the second-axis operation command based on the second component.

6. A system according to claim 1,
wherein the computer comprises a mobile terminal, and
wherein, when a state in which a long-axis direction of the mobile terminal is a vertical direction, the region allocation unit is configured to allocate the second region to a bottom portion of the operation region such that the second region has a predetermined area ratio.

7. A system according to claim 1,
wherein the computer comprises a mobile terminal, and
wherein, when a state in which a long-axis direction of the mobile terminal is a horizontal direction, the region allocation unit is configured to allocate the second region to one of a left side portion or a right side portion of the operation region such that the second region has a predetermined area ratio.

8. A system according to claim 1 non-transitory computer readable medium, wherein the instructions are further configured to cause the computer to function as:
an object operation unit configured to execute, in response to at least one of the first operation command or the second operation command, the at least one of the first operation command or the second operation command to operate the object arranged within the virtual space; and
an image generation unit configured to generate a virtual space image in which the object is arranged in order to display the virtual space image on a display unit of the computer.

9. A system according to claim 1,
wherein the computer is connected to a head-mounted display (HMD) system through communication, and
wherein the HMD system comprises:
an HMD configured to display a virtual space image in which the object is contained; and
an HMD computer connected to the HMD, the HMD computer comprising:
an object operation unit configured to execute, in response to reception, from the computer, of at least one of the first operation command or the second operation command to operate the object, the at least one of the first operation command or the second operation command to operate the object arranged within the virtual space; and
an image generation unit configured to generate the virtual space image in which the object is arranged in order to display the virtual space image on the HMD.
